(19) United States
(12) Patent Application Publication
(10) Pub. No.: US 2008/0002880 A1
(43) Pub. Date: Jan. 3, 2008

(54) SYSTEMS AND METHODS FOR FUSING OVER-SAMPLED IMAGE DATA WITH THREE-DIMENSIONAL SPATIAL DATA

(75) Inventors: Stanley E. Coleby, Holladay, UT (US); Brandon J. Baker, Salt Lake City, UT (US)

Correspondence Address: MADSON & AUSTIN, 15 WEST SOUTH TEMPLE, SUITE 900, SALT LAKE CITY, UT, 84101, US

(73) Assignee: InteliSum, Inc., Salt Lake City, UT (US)

(21) Appl. No.: 11/772,660

(22) Filed: Jul. 2, 2007

Related U.S. Application Data
(60) Provisional application No. 60/806,450, filed on Jun. 30, 2006.

(51) Int. Cl. G06K 9/00

(52) U.S. Cl. 382/154

(57) ABSTRACT

Image data and 3-D spatial data are acquired for an object or scene. Non-unique (over-sampled) image data exist for at least one point on the object or in the scene. A selection mechanism is established for choosing one datum or set of data over another where over-sampled image data exist. The desired image data are isolated or blended to produce a single datum or set of data to represent the image of 3-D spatial data.

### RELATED APPLICATIONS

This application is related to and claims priority from U.S. Patent Application Ser. No. 60/806,450, filed Jun. 30, 2006, for Systems and Methods for Fusing Over-Sampled Image Data with Three-Dimensional Spatial Data, with inventors Stanley E. Coleby and Brandon J. Baker, which is incorporated herein by reference.

### FIELD TECHNICAL

The present invention generally relates to three-dimensional imaging systems. More specifically, the present invention relates to systems and methods for fusing a set of image data with three-dimensional (3-D) spatial data, such as light detection and ranging (LIDAR) data.

### BACKGROUND

The related art includes, among other things, electronic devices (potentially including software) whereby image data and LIDAR data are obtained in a time-synchronous manner, as described by U.S. Pat. No. 6,664,529 issued to Pack, et al., entitled “3D Multispectral LIDAR,” which is expressly incorporated by this reference. Pack's work covers images that are taken with a digital camera simultaneously with a LIDAR scanner, and are then time-synchronized. The present invention encompasses fusing images in a way that is not dependent upon time-synchronization. In other words, this invention relates to gathering image data and 3-D spatial data at potentially different times. In

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a diagram illustrating an exemplary Image A and an exemplary Image B that can be applied to an exemplary polygonal model C;

FIG. 2 is a diagram illustrating one embodiment of a vector c̅ₘⱼ that is the vector from a camera to the relative location on an exemplary image; and

FIG. 3 is a diagram illustrating an embodiment of planar surface A with normal angle n̅, of which multiple photographs are taken from camera locations B and C at directions c̅₁ and c̅₂ respectively.

### DETAILED DESCRIPTION

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

The present invention includes electronic devices (that may include software) whereby digital data from multiple images is fused to polygons formed with 3-D spatial data to create 3-D graphical objects that may be displayed, for example, on a computer monitor. The polygons are formed using a series of proximate 3-D data points to generate a flat surface within the three-dimensional object.

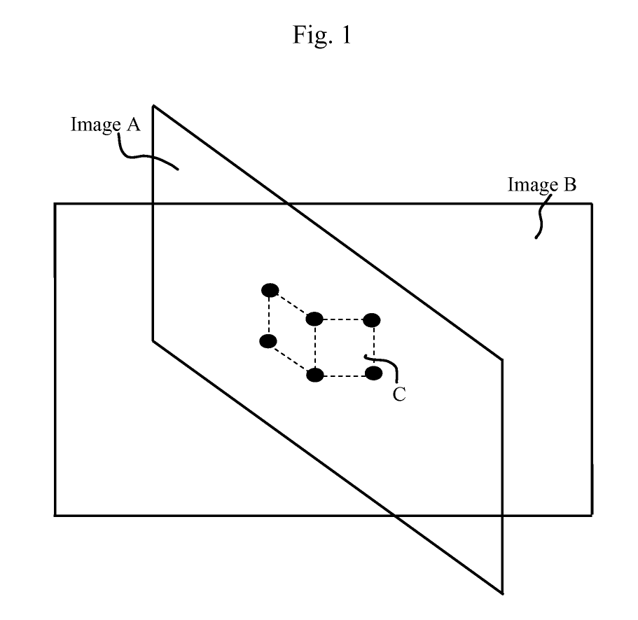

As illustrated in FIG. 1, a user may obtain 3-D spatial data, and then capture image data related to that 3-D spatial data with one or more image capturing devices (e.g., a digital camera). The desired image resolution or the optical limitations of the image capturing device may inhibit the user from obtaining sufficient image data to correspond with the 3-D spatial data using only one captured image. Consequently, a user may need to obtain multiple images to fuse with the polygons in 3-D spatial data. Typically, a user would over-sample image data with respect to 3-D spatial data. This means that more than one image, image A and image B in FIG. 1, could correspond to similar 3-D spatial data points, C. The method of selection of one image over another, or a calculated combination of the multiple image texture maps, is important to accurately represent a scene, area, or object depicted by the data. Ensuring a good fit between an image or images and the polygons formed with 3-D spatial data, and selecting an image of sufficient quality, are crucial for accurate representation of such a scene.

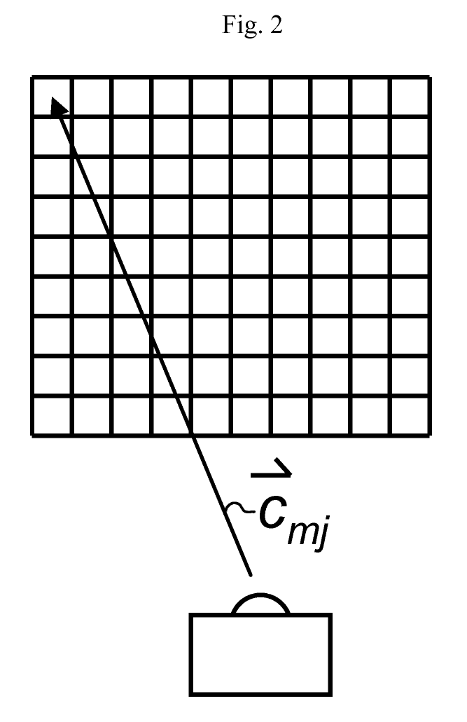

The normalized vector that is perpendicular to the plane of a polygon in the 3-D spatial data is called the normal vector, n̅ᵢ, where the subscript i indexes each of the polygons. Another important quantity can be used to describe the set of vectors that are directed from the camera to each of the pixels corresponding to objects under inspection. These vectors are labeled c̅ₘⱼ where subscript m indexes each individual pixel and j indexes each of the images, as illustrated in FIG. 2. The absolute value of the dot product of n̅ᵢ and c̅ₘⱼ is dⱼ. That value registers between 1 and −1. A value of 1 indicates that both vectors are parallel and oriented in the same direction. A value of 0 indicates that the vectors are perpendicular. A value of −1 indicates that the vectors are oriented in opposite directions. The present invention uses the absolute value of the dot product to determine which image or combination of images best fit the polygons formed with 3-D spatial data. The more parallel the vectors, the more likely that the corresponding image data will fit with the polygons. Image data that is perpendicular to the plane of the polygon probably has very little or no meaningful image data about the polygon in question because it is essentially an image from the side of the polygon. Image data that is parallel to the plane of the polygon probably has a significant amount of image information because it comprises a frontal view of the region defined by the polygon.

The present invention calculates the final color texture map vector V[u,v] (composed of red, green, and blue intensity values or intensity values for another color space, such as cyan, magenta, yellow, and black (CMYK)) based on the following equation:

$$\vec{V} [ u , v ] = \frac{{\sum }_{j} {w}_{j} {d}_{j} {\vec{P}}_{j} [ u , v ]}{{\sum }_{j} {w}_{j} {d}_{j}} \qquad Formula 1$$

where wⱼ is a weighting factor that is a function of each of the normal vectors of the polygons in the scene and c̅ₘⱼ, and P̅ⱼ[u,v] is the vector of color values (r, g, b) for image j. Typically, wⱼ would decrease as the angle between the vectors increased; however, due to variance in image quality and other mitigating factors, wⱼ could be any mathematical function, determined uniquely for each specific application, generally dependent upon the x, y, and z components of c̅ₘⱼ and the normal vector of any polygon. The weighting factor, wⱼ, allows the user to make factors (other than the absolute value of the dot product of n̅ᵢ and c̅ₘⱼ), such as lighting, hue, saturation, etc., carry greater weight in the determination of which image or combination of multiple images best represents the scene, area, or object depicted by the data. The weighting factor thus empowers the user with flexibility and provides for a higher level of accuracy in representing a scene, area, or object in specific circumstances.

A few possible embodiments for illustrative purposes might include, but are not limited to the following variations of the weighting factor: First, but not necessarily most important or most widely used, wⱼ=k, where k is constant for all j. This would result in one image gradually fading out as it overlapped another. The one image would be completely faded (to zero) when n̅ᵢ and c̅ₘⱼ are perpendicular, i.e., when an image is perpendicular to the plane of the polygon it has no meaningful image data to contribute to the overall 3-D image or, alternatively, when an image is parallel to the plane of the polygon it may have a signification amount of information to contribute. This embodiment, determines which image data or which combination of image data to use based on dⱼ. Thus, making wⱼ=k where k is constant for all j, makes the absolute value of the dot product the only factor used for selecting the image or combination of images to represent a scene, area, or object depicted by the data.

Second, if wⱼ=dⱼ, Formula 1 becomes

$$\vec{V} [ u , v ] = \frac{{\sum }_{j} {d}_{j}^{2} {\vec{P}}_{j} [ u , v ]}{{\sum }_{j} {d}_{j}^{2}} , \qquad Formula 2$$

which would also cause one image to fade out to zero as it overlapped another. However, this embodiment would cause the overlapping image to fade more rapidly than in Formula 1.

Third, if wⱼ=dⱼ², (1) becomes

$$\vec{V} [ u , v ] = \frac{{\sum }_{j} {d}_{j}^{3} {\vec{P}}_{j} [ u , v ]}{{\sum }_{j} {d}_{j}^{3}} , \qquad Formula 3$$

which would cause the overlapping image to fade even more rapidly than in Formula 2.

Fourth, in the limit:

$${w}_{j} = {lim}_{n -> ∞} {d}_{j}^{n} , \qquad Formula 4$$

Formula 1 becomes

$$\vec{V} [ u , v ] = {lim}_{n -> ∞} \frac{{\sum }_{j} {d}_{j}^{n} {\vec{P}}_{j} [ u , v ]}{{\sum }_{j} {d}_{j}^{n}} , \qquad Formula 5$$

which would cause the image with the largest dot product to be chosen, and all others ignored. Additionally, if two or more dot products are equal, the average of the RGB or CMYK values of each of the images would be used for the value of the final color vector.

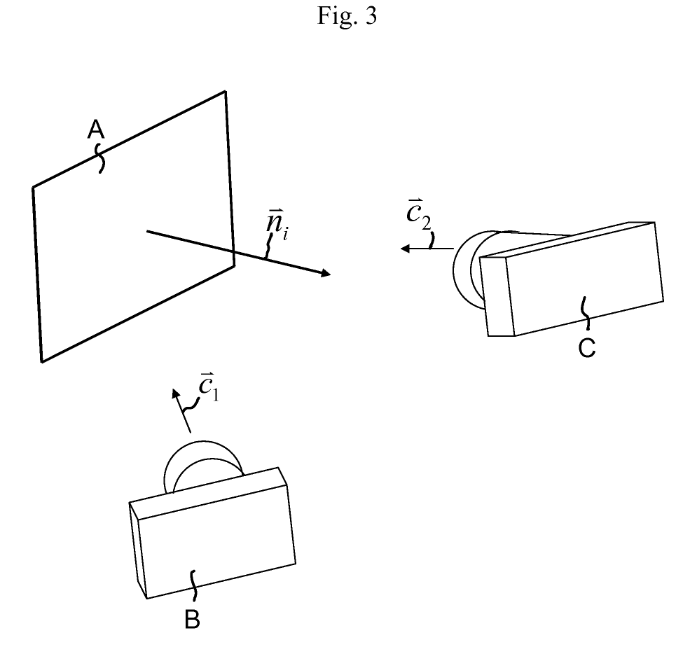

Another potential embodiment of the present invention might require the implementation of a parallax correction algorithm prior to fusing the image data. As illustrated in FIG. 3, image data may be gathered from various locations relative to a scene, object, or area. The 3-D spatial data make up the vertices of polygon A; two photographs are taken of the same scene from differing viewpoints, B and C. The dot products

d₁= n̅ᵢ· c̅ₘⱼ₁, Formula 6

and

d₂= n̅ᵢ· c̅ₘⱼ₂ Formula 7

used in Formula 1 are computed, typically after the images associated with c̅ₘ₁ and c̅ₘ₂ have undergone a parallax correction.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for fusing over-sampled image data that can be applied to a three-dimensional model, comprising:
acquiring image information related to a three-dimensional model;
applying proper weighting factors to each set of image data;
formulating a single image from the multiple images; and
acquiring three-dimensional model information.

2. The method of claim 1, wherein the three-dimensional model is acquired by a lidar device.

3. The method of claim 1, wherein multiple images are acquired for the same three-dimensional model.

4. The method of claim 1, wherein weighting factors are applied to each set of image data.
